(19) United States
(12) Patent Application Publication
(10) Pub. No.: US 2008/0286517 A1
(43) Pub. Date: Nov. 20, 2008

(54) SELF-ADHESIVE PRODUCT HAVING A LASER SLIT RELEASE LINER AND METHOD OF MAKING SAME

(75) Inventors: Thomas J. Zickell, New Castle, NH (US); John M. Lackner, Nashua, NH (US); James Karlis, Pelham, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Northern Elastomeric, Inc., Brentwood, NH (US)

(21) Appl. No.: 11/749,360

(22) Filed: May 16, 2007

(51) Int. Cl. B32B 33/00; B05D 5/10

(52) U.S. Cl. 428/42.2; 427/207.1; 428/40.1

(57) ABSTRACT

A self-adhesive product having a laser slit release liner and method provide improved performance and lower materials cost in self-adhesive products such as roofing and underlayment products, through-wall flashing, below-grade waterproofing and other rolled or flat roofing or other such self-adhesive weatherproofing products. A single piece release liner is applied to a roll or liner of material over a self-adhesive layer of the material. The release liner is cut into two or more segments using a laser beam. The laser beam oxidizes the adhesive region of the self-adhesive material in the area under the laser beam used to slit the release liner, thereby eliminating or minimizing unwanted adhesion caused by the migration of adhesive material when the product is rolled, stacked or stored. The laser beam may be used to create two or more segments in the release liner in a linear or curvilinear fashion.

### FIELD OF THE INVENTION

This invention is drawn to the field of stock materials and coating processes, and more particularly, to a self-adhesive product having a laser slit release liner and a method of manufacturing the same.

### BACKGROUND OF THE INVENTION

To provide the best products at the best price, it is necessary that self-adhesive roofing and underlayment products, through-wall flashing, below-grade waterproofing and other such self-adhesive weatherproofing products minimize materials usage to lower product costs while maximizing the manner that the products perform.

Self-adhesive weatherproofing products having split or multi-part release liners allow for the removal of some part or segment of the release liner while leaving other parts or segments covering the self-adhesive layer which facilitates installation. One common form uses two (2) release liners that are overlapped in the middle and that can be independently removed to prevent self-adhesion when rolled while another two (2) part release liner system employs a separate release liner strip to prevent self-adhesion when rolled. There are also one piece release liners which are perforated to provide for part or segment removal and one piece release liners having embedded pull strips that cut the release liner when lifted, allowing removal of a segment of the release liner to partially expose the adhesive of the self-adhesive weatherproofing membrane. Such prior art release liner systems and techniques are disclosed, for example, by U.S. Pat. No. 6,235,364 to Schaughency et al., U.S. Pat. No. 5,916,654 to Phillips et al. and U.S. Pat. No. 6,426,129 to Kalwara et al.

All of the heretofore known self-adhesive weatherproofing products having split or multi-part release liners however have been disadvantageous. The extra materials needed to prevent undesirable self-adhesion when rolled have added to materials usage and resulted in increased product costs for the two-piece release systems. Moreover, both the perforated tear line of the one piece release liners as well as the heretofore known two (2) piece release liner systems have been subject to undesirable “zippering,” which is unwanted tearing of the segment or part as it is being removed. Finally, because a manufacturer may have equipment to prepare a release liner of a particular configuration, it is difficult to provide a release liner having a customer specific configuration unless additional supplies and/or equipment are purchased, making this undesirable from the manufacturer's perspective.

Accordingly, a need exists for a method of providing a release liner on a self-adhesive rolled material that reduces release liner material waste and cost and which provides easy separation and no self-adhesion when the material is rolled up on itself.

### SUMMARY OF THE INVENTION

In accordance with the present invention, a self-adhesive material having a laser slit release liner product and method are disclosed that eliminate the need for material usage extra to the release liner itself thereby reducing product costs and that reduce if not eliminate unwanted “zippering” during installation thereby improving product performance, ultimate end user satisfaction and overall product acceptance.

The self-adhesive product having a laser slit release liner in accordance with the present invention comprises a release liner layer abutting a liner of material having a self-adhesive substrate layer. The release liner is removable one from the self adhesive substrate layer. The self-adhesive substrate layer has an outermost adhesive surface that is exposed when the release liner is removed. The release liner layer begins with a single liner and is divided into one or more segments by a thin laser beam. The slitting of the release liner by the laser beam produces abutting but slightly spaced apart, closely facing micro-melted or micro-burned edges between neighboring segments of the release liner, and oxidized adhesive in the area of the adhesive layer under the laser slit release liner. The micro-melted or micro-burned edges of the release liner reduce if not eliminate zippering when the release liner segments are independently removed during installation.

The outermost surface of the self-adhesive substrate layer that is adhesive is oxidized in the region under the abutting edges of adjacent release liner segments, providing a strength of adhesion in the oxidized surface region that is less relative to the adhesive strength of the adhesive in regions remote from the oxidized region. The region of reduced adhesive strength prevents unwanted adhesion of the material during transport or storage of the rolled self-adhesive material. The release liner layer may be mono-layer constructed or co-extrusion constructed and may be segmented into two or more adjacent segments having linear and/or curvilinear abutting and closely facing micro-melted or micro-burned edges. In addition, the release liner may be a polymeric release liner as well as a poly-coated paper release liner.

The adhesive substrate layer may be any base material suitable to be coated or impregnated partially or completely with a mastic or adhesive material, such as asphalt, which may be fashioned of one or more layers each of one or more materials.

The method of fabricating a self-adhesive product having a laser slit release liner in accordance with the present invention comprises, in one embodiment, the acts of continuously fabricating a length of an adhesive substrate by applying a mastic or adhesive material to a web; continuously applying a release liner layer to cover the full width of the adhesive weatherproofing substrate; and directing a thin beam of laser energy onto the release liner with such intensity and focus as (1) to slit the release liner into two or more adjacent segments having slightly spaced apart, abutting and closely facing edges, (2) to oxidize the adhesive under the region of the spaced apart and abutting and closely facing edges between adjacent segments of the laser cut release liner to reduce if not eliminate the migration of adhesive outwardly from the slit to dull the surface of the adhesive substrate confronting the interstices between neighboring segments of the release liner to prevent unwanted adhesion. The laser may be continuous or pulsed and the release liner may be laser slit in any desired pattern to include linear and/or curvilinear slits between neighboring segments in any longitudinal, lateral, or other orientations.

The present invention provides improved performance, the ability to customize slit position and lower materials cost in self-adhesive roofing and underlayment products, through-wall flashing, below-grade waterproofing and other such rolled or flat self-adhesive weatherproofing products.

### BRIEF DESCRIPTION OF THE DRAWINGS

These and other objects, advantageous features and inventive aspects of the present invention will become apparent as the invention becomes better understood by referring to the following, solely exemplary, detailed description of the presently preferred embodiments, and to the drawings, wherein:

FIG. 1A is a side pictorial view illustrating a self adhesive product having a laser slit release liner in accordance with the present invention;

FIG. 1B is an exploded, schematic side pictorial view illustrating the principles of the self-adhesive weatherproofing product having a laser slit release liner of the present invention; and

FIG. 2 is a block diagram of the method of fabricating a self-adhesive product having a laser slit release liner in accordance with the teachings of the present invention.

### DETAILED DESCRIPTION OF THE PREFERRED EMBODIMENTS

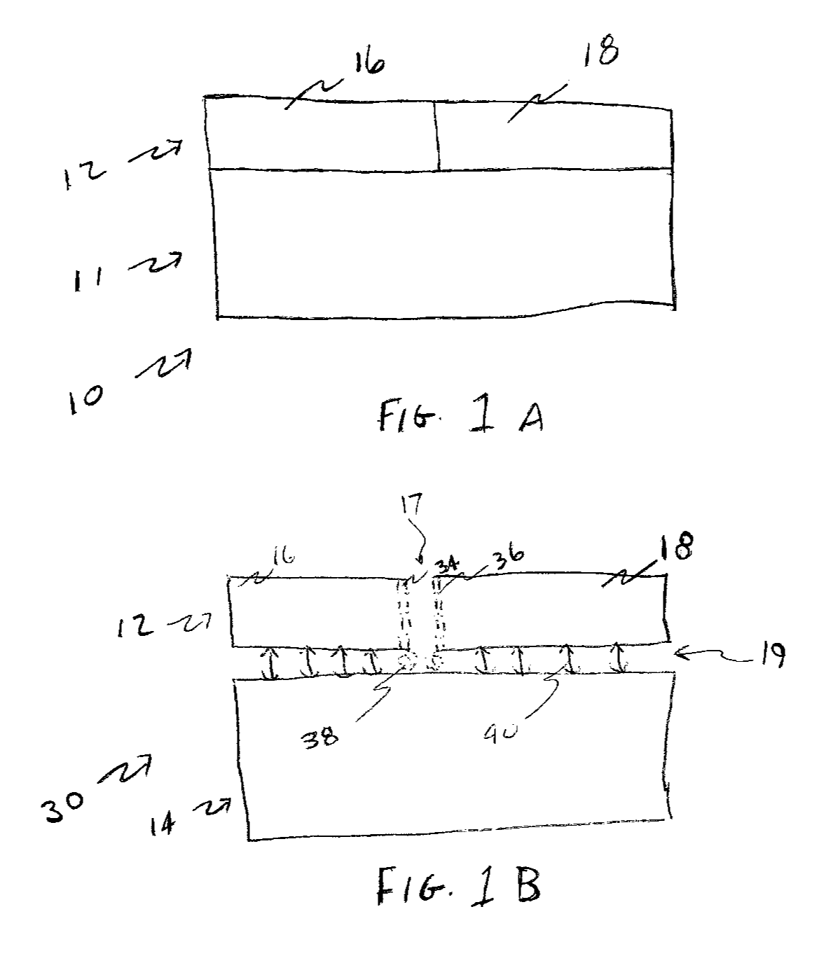

Referring now to FIG. 1A, generally designated at 10 is a cross-sectional view illustrating the self-adhesive product having a laser slit release liner of the present invention. The self-adhesive product having a laser slit release liner 10 includes a release liner layer designated generally at 12 and a substrate layer 14 having at least one outermost mastic or adhesive surface facing the release liner layer 12. The release liner 12, laser cut into neighboring longitudinal segments 16, 18, allows the segments 16, 18 to be individually removed from the outermost adhesive surface of the substrate layer 14 to expose the adhesive to enable the adhesive surface to be attached to another surface during installation in well-known manner.

One feature of the present invention is the ability for a manufacturer to easily and quickly adjust its manufacturing process to allow it to produce a substrate having a release liner configured according to each customer's specification. For example, the laser slit does not have to be in the middle of the release liner. The laser slit can be provided in one or more places anywhere along the width of the substrate.

For example, if a customer wishes the slit to be approximately 9 inches from one edge, this can be easily accomplished. The advantage of locating a slit this close to one edge of, for example, a piece of roofing material is that the end-user can roll out a self-adhesive roofing material product onto a substrate deck, remove the 9 inches of release liner and temporarily “tack” down the product. When the user is fully confident that the product is in the correct place, he can then remove the remaining 27 plus inches of release liner and firmly adhere the product to the underlying substrate.

Multiple slits across the liner can also be accomplished in one operation. One advantage of the present invention is that the manufacturer's equipment can easily and quickly be customized to each customer's request without purchasing different size release liner stock and incurring down time for job changes. In addition, the slit need not be straight or linear but rather, may be curvilinear or any design or shape desired.

Referring now to FIG. 1B, generally designated at 30 is an exploded, cross-sectional view useful in explaining the principles of the self-adhesive product having a laser slit release liner in accordance with the teachings of the present invention. As an aid to explanation, the figure is exploded so as to accentuate on the one hand the interface and space 17 between the neighboring segments 16, 18 of the laser slit release liner layer 12 and also the interface 19 between the confronting adhesive surface of the substrate layer 14 and segments 16, 18 of the release liner layer 12.

As one product of the cutting laser beam used to create the release liner segments, the spaced apart and closely facing edges of neighboring segments 16, 18 are micro-melted (in the case of a polymeric release liner) or micro-burned/melted (in the case of a poly-coated paper release liner) as schematically illustrated by dot/dash lines 34, 36. The micro-melted or micro-burned, spaced apart and closely facing edges 34, 36 of the segments 16, 18 have been found to reduce if not eliminate unwanted “zippering” during their individual removal from the self-adhesive weatherproofing substrate layer 14.

As a further product of the cutting laser, the adhesive surface of the substrate layer 14 itself in the region thereof 38 confronting or underlying the micro-melted or micro-burned, spaced apart and closely facing edges 34, 36 is itself oxidized. As schematically illustrated by the double headed arrows 38, 40 respectively in dashed and solid outline, the adhesive strength of the self-adhesive weatherproofing substrate layer 14 is less in the oxidized region 38 than in regions remote from the oxidized region 40. Having such an oxidized region 38 has been found to reduce if not eliminate unwanted adhesion of the product when rolled or placed on itself and caused by adhesive migrating out of the space 17 between the release liners 16 and 18.

As is apparent to those skilled in the art, the width of the laser beam and the strength of the laser needed to create the slit 17 will be dependent on the type of material used for the release liner 12 and the thickness of the release liner 12.

As will be readily appreciated by those of skill in the art, by having eliminated the need for any materials extra to the laser slit release liner while at the same time reducing if not eliminating unwanted zippering as well as adhesion during storage, transport and installation, the present invention provides improved performance at minimized material cost for self-adhesive rolled and flat products such as, but not limited to roofing and underlayment products, through-wall flashing, below-grade waterproofing and other such self-adhesive weatherproofing products in which plural, individually removable release liner segments are necessary or desirable.

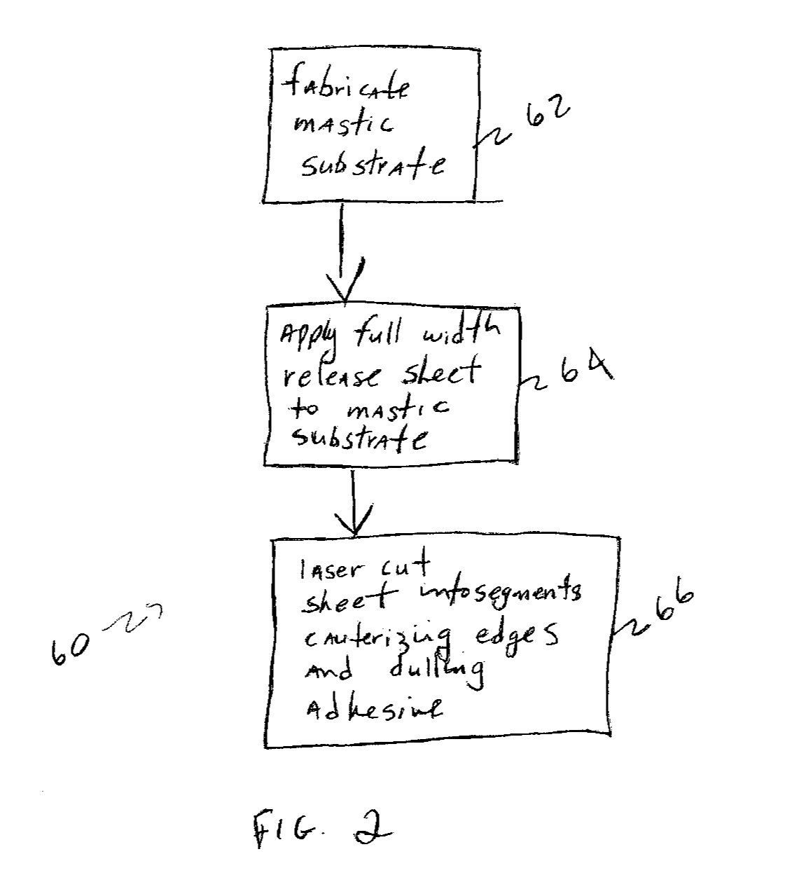

Referring now to FIG. 2, generally designated at 60 is a block diagram of the method of fabricating self-adhesive product having a laser slit release liner of the present invention. As shown by block 62, in a first coating act, the adhesive substrate layer is fabricated by applying, in any well known manner, a mastic or adhesive material, such as rubberized asphalt, to a moving stock web material. As shown by block 64, the release liner layer of any desired type, in a second step, is applied in well known manner to the adhesive substrate layer fabricated in the step 62 continuously with the advance of the moving web material. The release liner is a single piece and the width of the single piece of applied release liner is generally substantially the same in width as the width of the substrate layer fabricated in the step 62. As shown by block 66, the applied release liner layer is then laser slit, in a next step, by directing a sufficient amount of laser energy onto the release liner with such intensity and focus as to segment the release liner into two or more neighboring segments having spaced apart and closely facing edges.

The directed laser energy is operative to micro-melt or micro-burn the spaced apart and closely facing edges between neighboring segments of the laser cut release liner and also serves to dull or oxidize the adhesive surface of the adhesive substrate confronting or underlying the space between neighboring release liner segments. The spaced apart and closely facing edges micro-melted or micro-burned by action of the directed laser energy have been found to reduce if not prevent unwanted zippering effects during individual segment removal and the dulled power of adhesion in the region of the adhesive surface oxidized by action of the directed laser energy has been found to reduce if not eliminate unwanted adhesion of the product on itself when rolled or stored against another piece of material.

The release liner layer may, for example, be mono-layer constructed or co-extrusion constructed, so long as the material(s) of the release liner layer prove capable of being laser cut into one or more segments so as to have micro-melted or micro-burned edges. The adhesive substrate layer may, for example, be single ply or have multiple layers, each of one or more materials, so long as its adhesive surface is capable of being dulled by action of the laser used to cut the release liner layer by reason of oxidation of the adhesive in the region confronting or underlying the micro-melted or micro-burned edges of the segments of the release liner to reduce if not eliminate unwanted adhesion when rolled or stacked.

As will be appreciated and known by those skilled in the art, the laser may be continuous or pulsed and the release liner cut in any desired pattern to include linear and/or curvilinear slits between neighboring segments in any longitudinal, lateral, or other orientation.

The present invention is not intended to be limited to a device or method which must satisfy one or more of any stated or implied objects or features of the invention and should not be limited to the preferred, exemplary, or primary embodiment(s) described herein.

Modifications and substitutions by one of ordinary skill in the art are considered to be within the scope of the present invention, which is not to be limited except by the allowed claims and their legal equivalents.

What is claimed is:

1. A self-adhesive product having a laser slit release liner, comprising:
a release liner layer and a substrate layer removable one from the other, the substrate layer having an outermost adhesive surface that is exposed when the release liner layer and substrate layer are separated from one another, the release liner layer having two or more adjacent segments formed by directing laser energy onto the release liner layer with such intensity and focus as to segment the release liner into two or more adjacent segments having abutting and closely facing edges, and wherein the outermost adhesive surface of the substrate layer is oxidized by said laser energy in the region of the substrate layer under the abutting edges between the adjacent segments of the release liner layer.

2. The self-adhesive product having a laser slit release liner of claim 1, wherein said release liner layer is a mono-layer constructed release liner.

3. The self-adhesive product having a laser slit release liner of claim 1, wherein said release liner layer is a co-extrusion release liner.

4. The self-adhesive product having a laser slit release liner of claim 1, wherein said release liner is a polymeric release liner and wherein said abutting edges of the release liner are micro melted or micro-burned by said laser energy, and wherein said micro-melted or micro-burned edges of said adjacent segments of said release liner layer are straight micro-melted or micro-burned edges.

5. The self-adhesive product having a laser slit release liner of claim 1, wherein said abutting, micro-melted or micro-burned edges of said adjacent segments of said release liner layer are curvilinear micro-melted or micro-burned edges.

6. The self-adhesive product having a laser slit release liner of claim 1, wherein said adhesive substrate layer includes a base material layer and an adhesive layer.

7. The self-adhesive product having a laser slit release liner of claim 1, wherein said adhesive surface is a self-adhesive rubberized asphalt surface.

8. The self-adhesive product having a laser slit release liner of claim 1, wherein said self-adhesive product is a self-adhesive waterproofing product.

9. A method of fabricating a self-adhesive product having a laser slit release liner, comprising the acts of:
continuously fabricating an adhesive substrate by applying an adhesive material to at least one surface of a moving web material;
continuously applying a release liner layer to cover generally the full width of the at least one surface of said adhesive substrate to which said adhesive material has been applied; and
directing laser energy onto the release liner layer with such intensity and focus as to segment the release liner into two or more adjacent segments having abutting and closely facing edges and to oxidize the outermost adhesive surface of the substrate layer in the region of the adhesive material on substrate layer under the abutting edges between the adjacent segments of the release liner layer.

10. The method of fabricating a self-adhesive product having a laser slit release liner of claim 9, wherein the act of directing laser energy is accomplished by a continuous wave laser.

11. The method of fabricating a self-adhesive product having a laser slit release liner of claim 9, wherein the act of directing laser energy is accomplished by a pulsed laser.

12. The method of fabricating a self-adhesive product having a laser slit release liner of claim 9, wherein the release liner layer is cut in a pattern that includes at least one linear slit between adjacent segments of the release liner layer.

13. The method of fabricating a self-adhesive product having a laser slit release liner of claim 9, wherein the release liner layer is cut in a pattern that includes at least one curvilinear slit between adjacent segments of the release liner layer.

14. A method of fabricating a self-adhesive product having a laser slit release liner, comprising the acts of:
providing a moving web material in the form of substrate to which has been applied an adhesive material to at least one surface of the substrate, and over which has been applied a release liner layer to cover generally a full width of the at least one surface of said substrate; and
directing laser energy onto the release liner layer with such intensity and focus as to segment the release liner into two or more adjacent segments having abutting and closely facing edges and so as to oxidize at least the outermost adhesive surface of the substrate layer in the region of the substrate layer under the abutting edges between the adjacent segments of the release liner layer.
